(19) United States
(12) Patent Application Publication
(10) Pub. No.: US 2004/0155387 A1
(43) Pub. Date: Aug. 12, 2004

(54) Graphite fiber-enhanced ceramic

(76) Inventor: Joseph D. Fivas, Tucson, AZ (US)

Correspondence Address: SNELL & WILMER, ONE ARIZONA CENTER, 400 EAST VAN BUREN, PHOENIX, AZ, 850040001

(21) Appl. No.: 10/360,503

(22) Filed: Feb. 6, 2003

(51) Int. Cl. B28B 1/00; C04B 35/00

(52) U.S. Cl. 264/640; 264/641; 501/95.2

(57) ABSTRACT

A composite material includes a plurality of continuous graphite fiber strands, bundles, or other such fiber configurations disposed within a hardened ceramic matrix. The continuous graphite fiber strands are preferably covered or “pegged” with a ceramic slurry (e.g., a porcelain ceramic slurry), attached to a pre-formed foundation, then fired to produce a fiber-enhanced ceramic structure. In this way, a may be efficiently fabricated for use in applications requiring high-strength materials capable of withstanding temperature extremes.

### FIELD OF INVENTION

The present invention relates, generally, to carbon fiber-based composite materials and, more particularly, to improved materials and structures incorporating a carbon or graphite fiber in a ceramic matrix.

### BACKGROUND OF THE INVENTION

There are many applications in which components must be designed to withstand high-temperature and/or low-temperature conditions. While ceramic materials provide desirable resistance to thermal extremes, such materials, while exhibiting high strength (particularly in compression), are generally brittle and prone to tensile failure.

Traditional carbon or graphite fiber-enhanced polymer materials may provide advantageous mechanical properties; however, such materials are generally not suitable for high-temperature conditions, particularly the set of conditions present in many aerospace applications such as atmospheric re-entry. Furthermore, fiber-enhanced polymer materials are prone to dramatic thermal expansion and contraction when subjected to thermal extremes.

Methods are therefore needed in order to overcome these and other limitations of the prior art.

### SUMMARY OF THE INVENTION

The present invention provides materials and components comprising a plurality of continuous graphite fiber strands, bundles, or other such fiber configurations disposed within a hardened ceramic matrix. In accordance with one aspect of the present invention, the continuous graphite fiber strands are substantially covered or “pegged” with a ceramic slurry (e.g., a porcelain ceramic slurry), attached to a pre-formed foundation, then fired to produce a fiber-enhanced ceramic structure. In this way, a may be efficiently fabricated for use in applications requiring high-strength materials capable of withstanding temperature extremes.

### BRIEF DESCRIPTION OF THE DRAWINGS

The subject invention will hereinafter be described in conjunction with the appended drawing figures, wherein like numerals denote like elements, and:

FIG. 1 is a conceptual cross-sectional overview of a graphite fiber-enhanced ceramic material in accordance with one embodiment of the present invention;

FIG. 2 is a conceptual cross-sectional overview of a graphite fiber-enhanced ceramic material in accordance with an alternate embodiment of the present invention;

FIG. 3 is a conceptual cross-sectional overview of a graphite fiber-enhanced ceramic material in accordance with an alternate embodiment of the present invention;

FIG. 4 is a conceptual cross-sectional overview of a graphite fiber patter in accordance with an alternate embodiment of the present invention;

FIG. 5 is a flowchart depicting an example method for fabricating a graphite fiber-enhanced ceramic form in accordance with one embodiment of the present invention;

FIG. 6 depicts a example method for covering a graphite fiber strand with a ceramic slurry; and

FIG. 7 depicts the step of attaching graphite fiber strands to an example foundation.

### DETAILED DESCRIPTION

Systems and methods in accordance with the present invention provide materials comprising a plurality of continuous graphite fiber strands integrated within a hardened ceramic matrix. In accordance with one aspect of the present invention, the continuous graphite fiber strands are substantially covered with a ceramic slurry, attached to a pre-formed foundation, then fired to produce a fiber-enhanced ceramic structure.

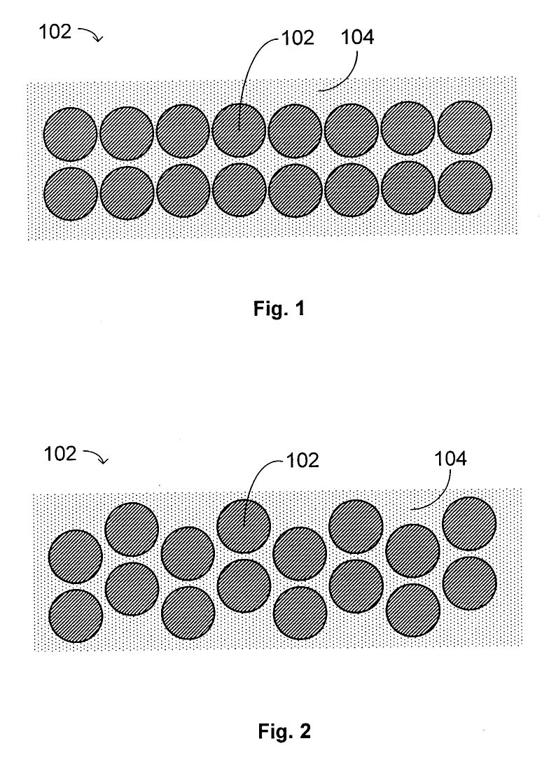

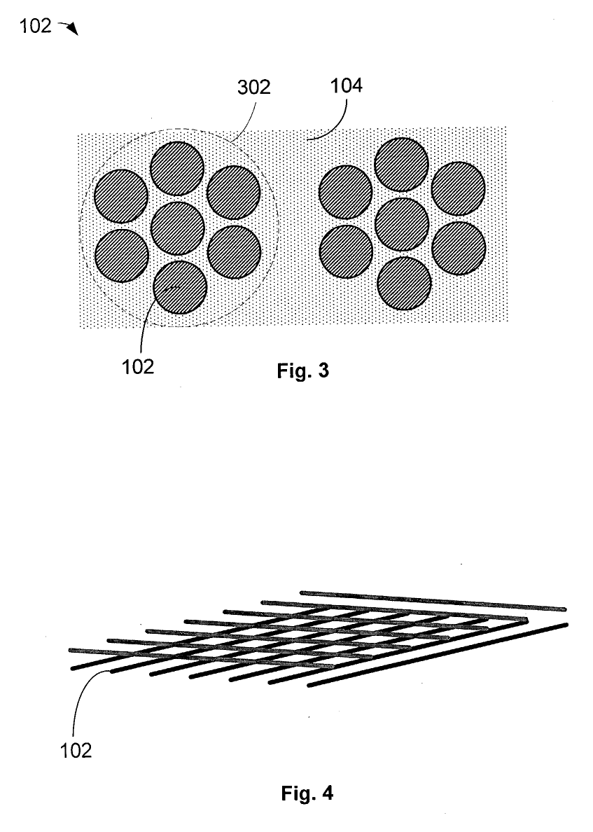

Referring to the cross-sectional diagram of shown in FIG. 1, in the finished product, a plurality of graphite fibers 102 (which may themselves comprise a plurality of individual “filaments”) are formed within a hardened ceramic matrix 104. It will be appreciated that the fibers 102 may be oriented in any convenient manner, and that FIG. 1 is presented as merely one configuration. For example, the fibers may also be placed parallel in a roughly staggered pattern as shown in FIG. 2. Alternatively, as shown in FIG. 3, groups or “bundles” 302 of fibers 102 may be intertwined or otherwise grouped together within matrix 104. Furthermore, as shown in FIG. 4, the fibers 102 may be configured as multiple layers having various orientations, e.g., alternating 90-degree orientations.

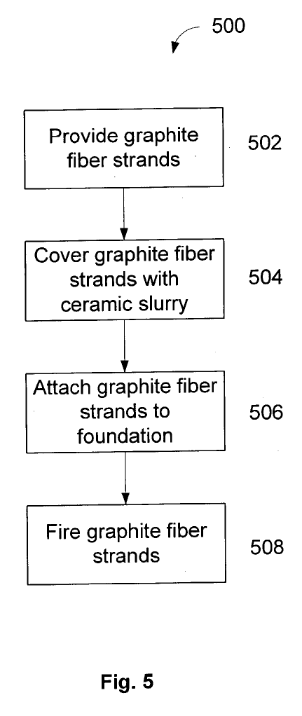

Having thus given an overview of a composite material in accordance with the present invention, an example method of fabricating such materials and components will now be described. Referring to FIG. 5, an exemplary processing method 500 begins with the selection of an appropriate carbon or graphite fiber material (step 502). In general, a carbon fiber is a fiber containing at least 90% carbon produced through controlled pyrolysis of an organic precursor. Conventional precursor materials include, for example, polyacrylonitrile (PAN), cellulosic fibers (e.g., Rayon, cotton, or the like), and phenolic fibers. The precursor material is treated at a temperature sufficient to pyrolize the oxygen, nitrogen, and hydrogen. In the case of PAN-based fibers, for example, the PAN is first subjected to an oxidative stabilization step in the range of about 200-300° C. The resulting fiber material is carbonized at approximately 1000° C. in an inert atmosphere. Finally, the fiber is subjected to a graphitization step at a temperature of between approximately 1500-3000° C. In this way, by carefully controlling the conditions of stabilization, carbonization, and graphitization, a fiber with the desired properties may be produced.

Carbon fibers may be categorized in a number of ways. For example, fibers are often grouped by their mechanical properties, i.e.: ultra-high-modulus (UHM), high-modulus (HM), intermediate-modulus (IM), high tensile (HT), or superhigh-tensile (SHT). Fibers may also be categorized by heat treatment method, i.e.: type I (high-heat-treatment or “HTT”), type II (intermediate heat, or “IHT”), or type III (low-heat treatment).

The term “graphite” fiber generally refers to a fiber which, because of particular processing conditions, achieves a carbon content in excess of about 99%. Such fibers are typically produced using a graphitization step at about approximately 2500° C. In this regard, while the present invention is often described herein in terms of “graphite fiber,” it will be appreciated that the invention is not so limited, and that the disclosed systems and methods may be applied to any suitable carbon fiber or other fiber material now known or later developed. Furthermore, as conventional techniques for forming graphite fibers are known in the art, such methods need not be described in detail herein.

Once a natural or synthetic fiber is used to form continuous carbon filaments, multiple filaments (i.e., on the order of many thousands of filaments) may then be combined into individual fibers, which are then wound onto spools. Suitable carbon fibers include, for example, any of the various continuous carbon fibers produced by Hexcel Corporation of Dublin, Calif. In a preferred embodiment, the carbon fiber comprises a suitable HM fiber.

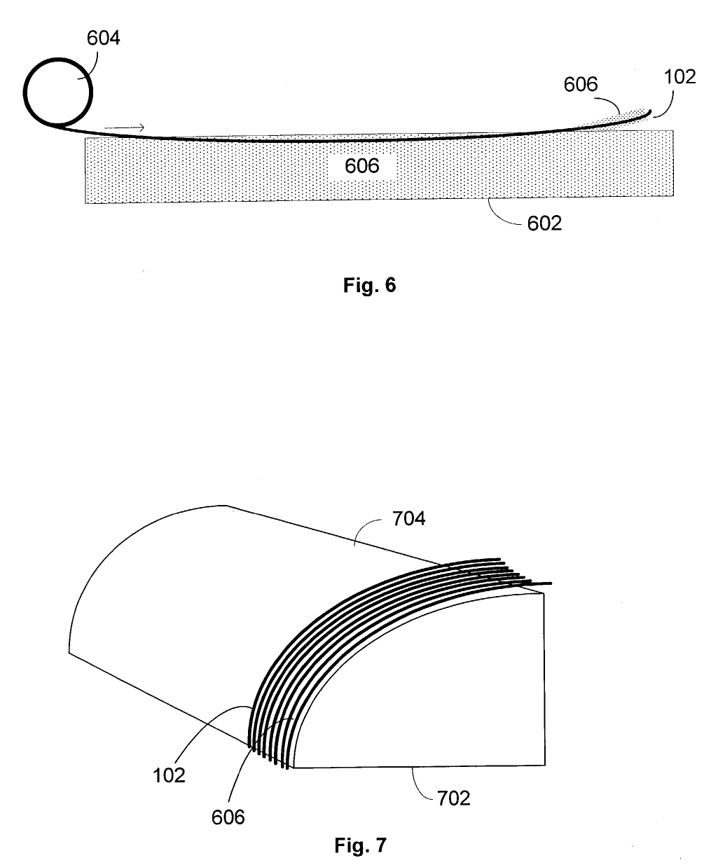

Next, in step 504, the graphite fiber strands are substantially covered with a suitable ceramic slurry. Referring to FIG. 6, for example, the fiber strand 102 may be unwound from a spool 604 in such a way that a portion of fiber strand 102 is immersed within a reservoir 602 (or “ceramic dip”) of slurry 606. As shown, strand 102 is preferably allowed a small amount of slack to facilitate the dipping procedure. The strand 102 exiting reservoir 602 is thus substantially coated (or “pegged”) with a layer of ceramic slurry 606.

In general, slurry 606 includes a fine ceramic powder (e.g., porcelain powder or the like), water, and a binder material. A variety of other may also be incorporated into the slurry. Next, in step 506, the graphite fibers (now substantially covered with the ceramic slurry) are suitably molded on, layered upon, wound around, or otherwise attached to a pre-formed foundation. That is, referring to FIG. 7, the fibers 102 (having slurry 606 interstitially disposed between the strands) are attached to an appropriate surface or surfaces 704 of a foundation 702. The fibers may be attached or wound on foundation 702 one at a time or in groups of, for example, twelve strands or more.

The fibers 102 may be attached to foundation 702 in any suitable pattern, for example, any of the various patterns described above in connection with FIGS. 1-4. Indeed, the fibers may be configured in any convenient manner depending upon the strength and flexibility desired.

Next, in step 508, the fiber strands and ceramic slurry are fired at a suitable temperature and pressure to form the final structure. The temperature and pressure of this step may be selected based on, among other things, the nature of the ceramic slurry.

Foundation 702 may be configured as a temperature-resistant component that remains integral with the fiber-enhanced ceramic (i.e., the component is effectively coated with the fiber-enhanced ceramic) or, alternatively, the foundation may be broken away or otherwise removed from the hardened layer of fiber-enhanced ceramic.

The materials disclosed may be used in a variety of applications. In the aerospace field, for example, the fiber-enhanced ceramic may be used to form the heat-resistant tiles used to protect a space-craft during re-entry. In the electronics field, the present invention may be used in connection with superconductor processes. The present invention may also be used, for example, in connection with extended life-time brake shoes and superconducting motors.

Although the invention has been described herein in conjunction with the appended drawings, those skilled in the art will appreciate that the scope of the invention is not so limited. Modifications in the selection, design, and arrangement of the various components and steps discussed herein may be made without departing from the scope of the invention as set forth in the appended claims.

What is claimed is:

1. A fiber-enhanced material comprising a plurality of continuous-strand carbon fibers within a hardened ceramic matrix.

2. The material of claim 1, wherein said carbon fibers comprise a graphite fiber.

3. The material of claim 1, wherein said ceramic matrix comprises a porcelain ceramic.

4. The material of claim 1, wherein said carbon fibers are disposed in a pattern selected from the group consisting of parallel strands, randomly-oriented strands, perpendicular strands, and woven strands.

5. A method of manufacturing a fiber-enhanced structure, said method comprising the step of:
providing a plurality of continuous carbon fiber strands;
substantially covering said continuous carbon fiber strands with a ceramic slurry to form a plurality of covered fiber strands;
providing a pre-formed heat-resistant foundation;
attaching said plurality of covered fiber strands to said foundation; and
firing said covered fiber strands to produce said fiber-enhanced structure.

6. The method of claim 5, further comprising the step of removing said foundation from said fiber-enhanced structure.

7. The method of claim 5, wherein said step of providing a plurality of carbon fiber strands includes the step of providing a plurality of graphite fiber strands.

8. The method of claim 5, wherein said step of attaching said plurality of pegged fiber strands to said foundation includes the step of disposing said plurality of pegged fiber strands in a pattern selected from the group consisting of parallel strands, randomly-oriented strands, perpendicular strands, and woven strands.

9. The method of claim 5, wherein said step of substantially covering said carbon fiber strands includes the step of dipping said plurality of carbon fiber strands in a reservoir of said ceramic slurry.
